(19) United States
(12) Patent Application Publication
(10) Pub. No.: US 2003/0205573 A1
(43) Pub. Date: Nov. 6, 2003

(54) Microwave firing furnace and microwave firing method

(76) Inventors: Kazunari Okumura, Anjyo-city (JP); Akira Kagohashi, Toki-city (JP); Akira Nishio, Toki-city (JP)

Correspondence Address: NIXON & VANDERHYE, PC, 1100 N GLEBE ROAD, 8TH FLOOR, ARLINGTON, VA, 22201-4714, US

(21) Appl. No.: 10/408,661

(22) Filed: Apr. 8, 2003

(30) Foreign Application Priority Data
Apr. 11, 2002 (JP) 2002-109129(PAT.

(51) Int. Cl. H05B 6/64

(52) U.S. Cl. 219/680; 219/683

(57) ABSTRACT

A microwave firing furnace comprises microwave heating means and a furnace chamber for holding a material to be fired containing an organic binder. A carrier gas introduction pipe introduces a carrier gas that contains oxygen at a concentration lower than that of the air to suppress the burning of the organic binder contained in the material being fired.

### BACKGROUND OF THE INVENTION

1. Field of the Invention

The present invention relates to a microwave firing furnace for irradiating a material to be fired such as a ceramic material containing an organic binder with microwaves and to a microwave firing method.

2. Description of the Related Art

A method of firing a material to be fired containing an organic binder includes a dewaxing step for removing the organic binder contained in the material to be fired and, sequentially, a firing step for heating the material to be fired to sinter it as the temperature is elevated. A carrier gas is used for carrying gasified substances, of the organic binder, generated from the substances being fired and is necessary for the dewaxing step of removing the organic binder from the material being fired, but is not usually used in the next step of sintering.

As an ordinary ceramic material for tableware and tiles, a clay is used for enhancing the moldability. In the ceramic material such as fine ceramics for imparting high degree of functions to the material to be fired, an organic binder is, in many cases, used instead of the clay to enhance the moldability. In this case, the organic binder contained in the material to be sintered is usually decomposed into carbon, carbides and gasified substances accompanying the heating. The carbide remains inside the material that is fired but the gasified substances are volatilized and burn. When there exist low-temperature portions in the material that is fired, the gasified substance may partly solidify on the surfaces of the material that is fired.

The substances solidified on the surfaces of the fired material, carbon and carbides remaining in the fired material burn as the firing temperature rises, and the removal of binder or dewaxing is completed. It has been said that the organic binder generally starts decomposing at about 170° C. and usually ends at about 450° C. The carbide generally starts burning at about 450° C. and usually ends at about 600° C.

The organic binder helps enhance the moldability but is accompanied, however, by the occurrence of inconvenience as described below because it decomposes into carbon, carbides and gasified substances due to heating.

1. The gas formed by the decomposition of the organic binder burns. In this case, the temperature of the burned portion rises locally producing a large temperature differential in the material being fired. Hence, the material being fired develops a problem such as cracking and deformation.

2. The gas formed by the decomposition of the organic binder solidifies on the surface of the material being fired, accounting for the occurrence of cracks and deformation in the material being fired.

3. Carbon and carbides remaining in the material being fired burn, whereby the temperature locally rises in the burned portion producing a large temperature differential in the material being fired and developing cracks and deformation in the material that is fired.

To cope with the above-mentioned inconvenience, the following countermeasures can be taken.

1. When the material to be fired is heated by being irradiated with microwaves, in general, the temperature inside the material to be fired tends to rise as compared to the outer peripheral surfaces of the material to be fired in contrast with other heating systems. Among the furnace walls forming the furnace chamber, therefore, the fire resisting material constituting the innermost wall containing the material to be fired is so selected as to possess a microwave absorption factor that is equal to, or greater than, that of the material to be fired. The surfaces of the composition to be fired are heated by utilizing the heat radiated from the fire resisting material constituting the innermost wall for containing the material to be fired, thereby to reduce the temperature differential between the interior and the surface of the material to be fired.

This countermeasure only, however, is not enough for completely eliminating the temperature differential, in the material to be fired, over the whole temperature region for removing the organic binder.

2. According to the method of introducing the carrier gas into the furnace chamber in the firing furnace, the material to be fired in the furnace chamber is cooled at a portion that easily comes in contact with the carrier gas producing a large temperature differential in the material to be fired. Therefore, a method has been employed according to which the carrier gas is introduced into the furnace after having been heated to the same temperature as the temperature in the furnace chamber. According to this method, the gas formed by the decomposition of the organic binder is conveyed together with the carrier gas out of the furnace, solving such an inconvenience that the gas formed by the decomposition of the organic binder solidifies on the surfaces of the material being fired. When the carrier gas is the air (oxygen concentration of about 21% in terms of a volume ratio), however, the burning of the material being fired is promoted at a portion that easily comes into contact with the air causing such an inconvenience that the temperature differential increases between the interior and the surface of the material being fired.

When the carrier gas is an inert gas such as nitrogen gas, further, carbon and carbides remaining in the material being fired burn insufficiently and cannot be removed by burning. In a sintering step which follows the step of removing the organic binder (dewaxing step), therefore, carbon and carbides burn causing a quick rise in the temperature, making it difficult to control the temperature to a sufficient degree in the firing step, which is an important step, accounting for the occurrence of cracks and deformation in the material being fired.

In order to eliminate the above defect, the temperature must be raised at a slow rate in the dewaxing step of removing the organic binder from the material being sintered. As a result, the advantage of the microwave heating furnace, which features a quick temperature-raising rate, is not necessarily utilized to a sufficient degree, and an extended period of time is required for removing the organic binder from the material being sintered.

The above tendency occurs conspicuously and particularly when there easily occurs a temperature differential in the material being fired as when the material (e.g., a honeycomb catalyst substrate of an exhaust gas purifying catalyst) of a honeycomb shape having a large surface area and a large apparent volume, is fired or when a stack of a plurality of thin plate-like materials is fired.

### SUMMARY OF THE INVENTION

The present invention was accomplished in view of the above-mentioned circumstances, and has the object of providing a microwave firing furnace which suppresses the oxygen concentration of the carrier gas flowing into the microwave firing surface, suppresses the oxygen concentration in the microwave firing surface, suppresses the combustion of carbon and carbides stemming from the organic binder and, as a result, is advantageous for shortening the time of the dewaxing step of removing the organic binder from the material being fired, and a microwave firing method.

A microwave firing furnace according to the present invention comprises microwave heating means and a furnace chamber for holding a material to be fired containing an organic binder and, further, has a carrier gas introduction pipe for introducing a carrier gas that contains oxygen at a concentration lower than that of the air to suppress the burning of the organic binder.

A microwave firing method of the present invention holds and burns the material to be fired containing an organic binder in a furnace chamber of a microwave firing surface while introducing, into the furnace chamber, a carrier gas containing oxygen at a concentration lower than that of the air in a temperature range where at least the organic binder burns or is removed.

The carrier gas contains oxygen and permits carbon and carbides stemming from the organic binder to burn. The carrier gas, however, contains oxygen at a concentration lower than that of the air and suppresses the burning of carbon and carbides stemming from the organic binder in the dewaxing step as compared to when the air only is used as the carrier gas. This suppresses the burning of carbon and carbides in a sintering step, which is an important step effected after the step of removing the organic binder, and suppresses a sharp local temperature rise in the material being fired. Therefore, the present invention makes it possible to favorably control the temperature in the step of firing and, hence, to suppress the occurrence of cracks and deformation in the material being fired.

That is, carbon and carbides remaining in the material being fired burn vigorously to sharply raise the temperature when the carrier gas contains oxygen at a high concentration. According to the present invention, therefore, the carrier gas contains oxygen at a low concentration to suppress the combustion reaction of the material being fired at a portion where a quick combustion takes place in order to decrease the temperature differential that occurs in the material being fired.

The present invention may be more fully understood from the description of preferred embodiments of the invention set forth below, together with the accompanying drawings.

### BRIEF DESCRIPTION OF THE DRAWINGS

In the drawings:

FIG. 1 is a diagram illustrating the constitution of a microwave firing furnace according to an embodiment of the present invention;

FIG. 2 is a diagram illustrating the constitution of a microwave firing furnace according to another embodiment of the present invention; and

FIG. 3 is a perspective view illustrating a material to be fired.

### DESCRIPTION OF THE PREFERRED EMBODIMENTS

According to the present invention, a carrier gas introduction pipe introduces, into the furnace chamber, a carrier gas which contains oxygen at a concentration lower than that of the air to suppress the burning of the organic binder. This makes it possible to suppress the burning of carbon and carbides stemming from the organic binder while conveying volatile components of the organic binder generated from the material to be fired out of the furnace. According to the present invention, therefore, provision is made of gas feed means for feeding, into the carrier gas introduction pipe, the carrier gas that contains oxygen at a concentration lower than that of the air to suppress the burning of the organic binder. The gas feed means includes oxygen gas-feed means for feeding an oxygen-containing gas such as the air into the carrier gas introduction pipe, and feed means for feeding a gas without containing oxygen or containing oxygen at a low concentration (argon gas, nitrogen gas or nitrogen enriched gas) into the carrier gas introduction pipe.

According to the present invention, provision is made of heating means for heating the carrier gas at a temperature in a region where at least the organic binder decomposes or is removed. There is no particular limitation on the system of heating means, and there can be employed an electric heater or a burner. The burner may be separate from, or integral with, the carrier gas introduction pipe.

According to the present invention, provision is made of heating means for heating the carrier gas before the carrier gas comes in contact with the material to be fired in the furnace chamber. The heating means may be an electric heater or a burner as described above. The carrier gas introduction pipe may also be so constituted as to serve as a burner for introducing the carrier gas which is burning into the furnace chamber.

According to the present invention, the oxygen concentration in the carrier gas is set to be from 0.5 to 16% and, particularly, from 2 to 16% in terms of a volume ratio. When the oxygen concentration is too low, carbon and carbides burn at a slow rate. When the oxygen concentration is too high, carbon and carbides burn so quickly that the temperature rises locally in the material being fired. By taking the above points into consideration, it is desired that the oxygen concentration in the carrier gas is from 2 to 16% in terms of a volume ratio, and the oxygen concentration in the carrier gas can be set to be 2 to 10%, 3 to 15% and 4 to 14% in terms of a volume ratio, as required.

According to the present invention, the oxygen concentration in the carrier gas can be varied accompanying a progress of the dewaxing step of removing the organic binder from the material being fired. Concretely speaking, the oxygen concentration in the carrier gas can be decreased accompanying a progress of the dewaxing step of removing the organic binder from the material being fired. Here, if the material being fired has a weak structure, carbon and carbides burn at a decreased rate and, hence, the material being fired contracts at a low rate offering improved safety against the occurrence of cracks and deformation.

Contrary to the above, it is also allowable to increase the oxygen concentration in the carrier gas accompanying a progress of the dewaxing step of removing the organic binder from the material being fired. In this case, the oxygen concentration can be increased by an amount by which the thermal load is decreased for the material that is fired due to a reduction in the combustible components in the material that is fired. This increases a rate of temperature rise offering an advantage of shortening the firing time as a whole.

According to the present invention, provision is made of control means such as a control valve for variably controlling the oxygen concentration in the carrier gas. The control means may be a system for controlling at least either the feeding rate per a unit time of the oxygen-containing gas feeding means that feeds the oxygen-containing gas such as the air to the carrier gas introduction pipe or the feeding rate per a unit time of the feeding means that feeds the gas without containing oxygen or containing oxygen at a low concentration (argon gas, nitrogen gas or nitrogen enriched gas) to the carrier gas introduction pipe. FIG. 3 illustrates the material to be fired, which is a catalyst substrate of an exhaust gas purifying catalyst, having numerous fine pores 3x and a very large surface area. The material to be fired is not limited to the catalyst substrate but may be any other material.

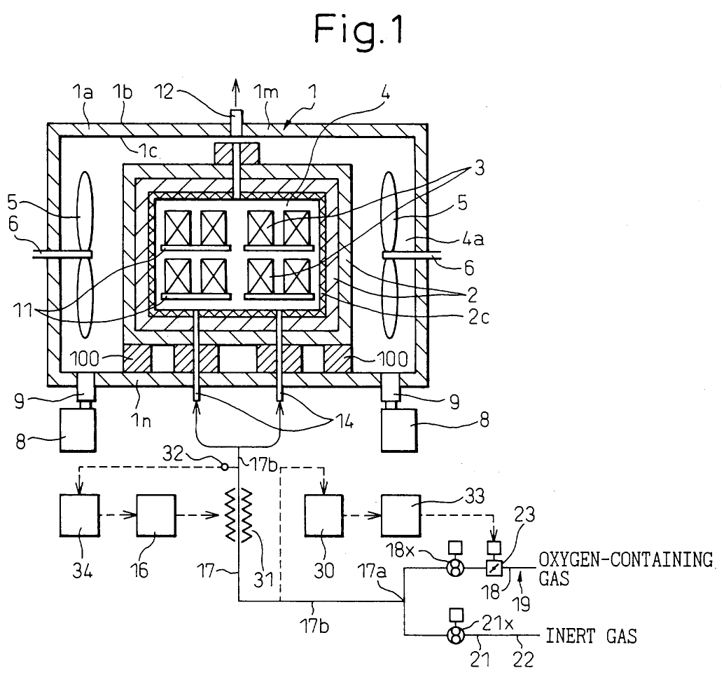

An embodiment of the present invention will now be concretely described with reference to FIG. 1 which illustrates a firing furnace. A furnace shell 1 includes stainless steel plates 1b, 1c of a double structure, and a fire resisting heat-insulating material la arranged between the stainless steel plates 1b and 1c of the double structure. A door is provided in the side surface, that is not shown, of the firing furnace, so that the material 3 to be fired can be put into, and taken out of, a furnace chamber 4. The furnace chamber 4 which is the firing chamber is formed in the central portion of the furnace shell 1. A heat-insulating member 2 sectionalizing the furnace chamber 4 is formed of a furnace material having a low microwave absorption factor. The heat-insulating member 2 is arranged on a fire resisting material 100 which is placed on a bottom portion in of the furnace shell 1 and is made of a material (porous alumina) having a low microwave absorption factor.

Diffusion fans 5 which serve as diffusion means are provided in spaces 4a between the side walls of the furnace shell 1 and the furnace chamber 4. Shafts 6 of the diffusion fans 5 penetrate through the furnace shell 1.

The spaces 4a are provided with waveguides 9 extending from microwave oscillators 8 installed outside the furnace. The waveguides 9 are for irradiating microwaves. The materials 3 to be fired are irradiated with the microwaves through the heat-insulating member 2 having a low microwave absorption factor of the furnace chamber 4.

The heat-insulating member 2 which forms the furnace chamber 4 and has a poor microwave absorption factor is formed in a plurality of layers which are constituted by materials having fire resistance which increases toward the inside. The innermost layer 2c of the heat-insulating material is made of a fire resisting material (inner lining material) having a microwave absorption factor equal to, or larger than, that of the material 3 to be fired.

One or more materials 3 to be fired are placed on fire resisting racks 11, which are holding means, in the furnace chamber 4. A ceiling portion lm of the furnace shell 1 is provided with a gas discharge port 12 communicated with the exterior of the furnace shell 1. A bottom portion 1n of the furnace shell 1 is provided with a plurality of carrier gas introduction pipes 14 communicated with the exterior of the furnace shell 1. The ends of the carrier gas introduction pipes 14 are communicated with the furnace chamber 4. To control the temperature in the furnace chamber 4, a measured value and a setpoint value are compared by a controller based on a temperature detected by a temperature sensor (not shown) provided in the furnace chamber 4, the output of the microwave oscillators 8 is controlled based on the deviation signals thereby to control the heating output of microwaves irradiated from the waveguides 9. The microwave oscillators 8 and the waveguides 9 constitute microwave heating means.

Referring to FIG. 1, the carrier gas introduction pipes 14 are provided in the bottom portion of the furnace shell 1. An introduction passage 17 for introducing the carrier gas into the carrier gas introduction pipes 14 includes feed means 19 having an oxygen-containing gas introduction passage 18 for feeding the oxygen-containing gas, and feed means 22 having an inert gas introduction passage 21 for feeding an inert gas (nitrogen gas, argon gas). The oxygen-containing gas introduction passage 18 is provided with a control valve 23, and a flow meter 18x is provided downstream of the control valve 23 to detect the flow rate of the oxygen-containing gas (air or the like) flowing through the oxygen-containing gas introduction passage 18. The inert gas introduction passage 21 is not provided with the control valve but is provided with a flow meter 21x for detecting the flow rate of the inert gas flowing through the inert gas introduction passage 21.

In the introduction passage 17, the oxygen-containing gas (air or the like) from the oxygen-containing gas introduction passage 18 and the inert gas from the inert gas introduction passage 21 meet together at a meeting portion 17a and flow into the carrier gas introduction pipes 14 through a combined flow passage 17b. Provision is made of an oxygen meter 30 (means for measuring the oxygen concentration in the carrier gas) for sampling the oxygen concentration in the carrier gas flowing through the combined flow passage 17b, a heater 31 (heating means) for heating the carrier gas flowing through the combined flow passage 17b, and a temperature sensor 32 (means for detecting the temperature of the carrier gas) for detecting the temperature of the carrier gas flowing through the combined flow passage 17b.

Controlling the oxygen concentration in the carrier gas.

The carrier gas flowing through the combined flow passage 17b is sampled by the oxygen meter 30. That is, the carrier gas flowing through the combined flow passage 17b is measured for its oxygen concentration by the oxygen meter 30. The setpoint oxygen concentration and the measured oxygen concentration are compared by an oxygen controller 33, and the control valve 23 in the oxygen-containing gas passage 18 is operated based on the deviation signals. Therefore, the control valve 23 works as control means for varying the oxygen concentration in the carrier gas. That is, when the oxygen concentration of the carrier gas flowing through the combined flow passage 17b is lower than a target concentration, the opening degree of the control valve 23 is increased to increase the oxygen concentration in the carrier gas introduced into the furnace chamber 4. When the oxygen concentration of the carrier gas flowing through the combined flow passage 17b is higher than the target concentration, on the other hand, the opening degree of the control valve 23 is decreased or the control valve 23 is closed to decrease the oxygen concentration in the carrier gas introduced into the furnace chamber 4. Thus, the oxygen concentration of the carrier gas blown into the furnace chamber 4 through the carrier gas introduction pipes 14 is maintained at a constant value or lies in a predetermined range.

Controlling the temperature of the carrier gas.

The temperature sensor 32 measures the temperature of the carrier gas flowing through the combined flow passage 17b. The temperature controller 34 compares the measured temperature and the setpoint temperature of the carrier gas flowing through the combined flow passage 17b, and controls the heating output of the heater 31 through an inverter 16 based on the deviation signals.

When the temperature of the carrier gas flowing through the combined flow passage 17b is lower than a target temperature, the heating output of the heater 31 is increased to elevate the temperature of the carrier gas. When the temperature of the carrier gas flowing through the combined flow passage 17b is higher than the target temperature, on the other hand, the heating output of the heater 31 is decreased or is turned off to lower the temperature of the carrier gas. Thus, the temperature of the carrier gas blown into the furnace chamber 4 from the carrier gas introduction pipes 14 is maintained at a constant value or lies in a predetermined range.

To maintain the temperature of the carrier gas to be the same as the temperature in the furnace chamber 4, the setpoint value of the controller (not shown) for controlling the temperature in the furnace may be brought to be the same as, or close to, the setpoint value of the temperature controller 34. When the temperature greatly drops before the carrier gas arrives at the furnace chamber 4, a margin may be imparted to the setpoint value of the temperature controller 34 by taking a drop of temperature of the carrier gas into consideration.

The oxygen concentration in the carrier gas differs depending upon the amount of the organic binder contained in the material 3 being fired, size of the material 3 being fired and thermal properties of the material 3 being fired, and may be suitably changed depending upon the conditions. That is, the oxygen concentration in the carrier gas can be varied over a range of, for example, 2% to 16% in terms of a volume ratio.

According to this embodiment, as will be understood from the foregoing description, the carrier gas contains oxygen and permits carbon and carbide stemming from the organic binder to burn. However, the carrier gas contains oxygen at a concentration lower than that of the air and suppresses the burning of carbon and carbide stemming from the organic binder in the dewaxing step as compared to when the air only is used as the carrier gas. Namely, in the dewaxing step, carbon and carbide stemming from the organic binder burn without causing a local and sharp temperature rise in the material 3 being fired. It is therefore possible to shorten the time of the dewaxing step for removing the organic binder from the material 3 being fired.

In the embodiment shown in FIG. 1, the inert gas introduction passage 21 is not provided with a control valve. In the embodiment, the flow rate of the oxygen-containing gas flowing into the oxygen-containing gas introduction passage 18 per a unit time is controlled by the control valve 23, so that the inert gas is fed into the carrier gas introduction pipes 14 at a flow rate which remains constant or lies within a predetermined region, to which, however, the invention is in no way limited. That is, the flow rate of the oxygen-containing gas flowing through the oxygen-containing gas introduction passage 18 per a unit time may be set to be constant or to lie in a predetermined range, and the inert gas introduction passage 21 may be provided with a control valve that is not shown to variably control the flow rate of the inert gas flowing in a unit time through the inert gas introduction passage 21.

When the absolute amount of the flow rate is important, the oxygen-containing gas introduction passage 18 and the inert gas introduction passage 21 are both provided with the control valve 23 to variably control the flow rate per a unit time of the oxygen-containing gas (air or the like) flowing through the oxygen-containing gas introduction passage 18 and to variably control the flow rate per a unit time of the inert gas flowing through the inert gas introduction passage 21.

When there is used a gas containing oxygen at a predetermined concentration, the oxygen concentration needs not be controlled but the oxygen-containing gas introduction passage 18 only may be controlled to make the gas containing oxygen flow at a suppressed concentration.

Test.

A test was conducted by using a microwave firing furnace shown in FIG. 1. In this test, the material 3 to be fired was sintered at a temperature of 1400° C. However, defects such as cracks and deformation occurring on the material 3 being fired can be detected in the firing step of up to 700° C. In this test, therefore, the heating was effected up to 700° C.

In this test, use was made of the microwave firing furnace shown in FIG. 1. The innermost layer 2c of the heat-insulating material constituting the furnace chamber 4 was coated on the surface thereof with a coating material containing SiC. In the test, the material 3 to be fired was cordierite of a honeycomb shape having a diameter of 103 mm, a height of 130 mm, a cell pitch of 0.85 mm and a cell thickness of 0.06 mm. The material 3 to be fired was used as a ceramic catalyst substrate for an exhaust gas purifying catalyst.

In the test, a mixed gas of the air and nitrogen was used as the carrier gas, and the oxygen concentration in the carrier gas was varied over a range of from 0.5% to 16%. The test was conducted even when the oxygen concentration in the carrier gas has exceeded 16%. The air heated to a temperature equal to the temperature in the furnace was introduced into the furnace chamber 4 at all times. In the test, the temperature was linearly elevated from normal temperature up to 700° C. Table 1 shows the results of test of when the oxygen concentration in the carrier gas was varied.

TABLE 1

| | | |
|---|---|---|
| O₂ concentration | Heating time (h) | Carbon in |
| in carrier gas | in which no defect | material |
| (%) | occurs up to 700° C. | Evaluation |

| | | | | |
|---|---|---|---|---|
| \mathring{1} | 0.5 to 2 | 8 | slightly | ◯ |
| \mathring{2} | 2 to 4 | 4 | no | ⊚ |
| \mathring{3} | 4 to 6 | 3 | no | ⊚ |
| \mathring{4} | 8 to 10 | 4.5 | no | ⊚ |
| \mathring{5} | 14 to 16 | 6.5 | no | ⊚ |

As shown in Table 1, the dewaxing step was favorable in any one of the cases of when the oxygen concentration in the carrier gas was from 0.5 to smaller than 2% in terms of a volume ratio, when the oxygen concentration in the carrier gas was from 2 to smaller than 4%, when the oxygen concentration in the carrier gas was from 4 to 6%, when the oxygen concentration in the carrier gas was from 8 to 10% and when the oxygen concentration in the carrier gas was from 14 to 16%. When the oxygen concentration in the carrier gas was smaller than 2%, however, the test results were good but the presence of carbon was recognized to some extent in the material 3 being fired, time was required for removing carbon, and an extended period of time was required for removing the binder. When the oxygen concentration of the carrier gas exceeded 16%, however, the state approached that of comparative example as compared to the case of when the oxygen concentration is 2 to 16%, and distinguished effects could not be expected.

When the oxygen concentration in the carrier gas was from 0.5 to smaller than 2% in terms of a volume ratio as shown in Table 1, no defect occurred in the material to be fired provided the heating time was selected to be 8 hours. When the oxygen concentration in the carrier gas was from 2 to 4% in terms of a volume ratio, no defect occurred in the material to be fired provided the heating time was selected to be 4 hours. When the oxygen concentration in the carrier gas was from 4 to 6% in terms of a volume ratio, no defect occurred in the material to be fired provided the heating time was selected to be 3 hours. When the oxygen concentration in the carrier gas was from 8 to 10% in terms of a volume ratio, no defect occurred in the material to be fired provided the heating time was selected to be 4.5 hours. When the oxygen concentration in the carrier gas was from 14 to 16% in terms of a volume ratio, no defect occurred in the material to be fired provided the heating time was selected to be 6.5 hours. By taking the above test results into consideration, it is desired that the oxygen concentration in the carrier gas is from 2 to 16% in terms of a volume ratio in order to suppress the occurrence of defects in the material being fired yet shortening the heating time. In particular, it can be said that the oxygen concentration in the carrier gas is desirably from 2 to 10%.

When thin plates such as of alumina substrates are to be fired in a stacked manner, there is an oxygen concentration in the carrier gas that is adapted depending upon the thickness (stacked state). When 5 pieces of plates are stacked, the greatest effect is obtained when the oxygen concentration in the carrier gas is from 12 to 16%. When the plates are stacked, the amount of the binder contained in the material being fired increases with an increase in the thickness thereof. It is therefore considered that the excess rate of decomposition of the binder is effectively suppressed by decreasing the oxygen concentration in the carrier gas. When 10 pieces of plates are stacked, the greatest effect is obtained when the oxygen concentration in the carrier gas is from about 4 to about 6%.

### COMPARATIVE EXAMPLE

In the Comparative Example, use was made of the microwave firing furnace shown in FIG. 1, and the innermost layer 2c of the heat-insulating material constituting the furnace chamber 4 was coated on the surface thereof with a coating material containing SiC. In the Comparative Example, further, the air (having an oxygen concentration of about 21% in terms of a volume ratio) was used as the carrier gas and was introduced into the furnace being heated up to a temperature equal to the temperature in the furnace at all times. The material 3 to be fired was the same as the one used in the above Test. The temperature was elevated at the same rate as that of the Test. The firing time was successively shortened starting from 15 hours.

The results of the test of the Comparative Example were as shown in Table 2. Namely, when the heating times were 15 hours and 12 hours in the dewaxing step, the ratio of crack occurrence was 0%, and no crack or deformation occurred in the material being fired. In the Comparative Example, however, when the heating time was shorter than 12 hours, small cracks occurred in the upper or lower surface of the honeycomb substrate. When the heating time was, for example, 10 hours, the ratio of cracks increased to 2% and small cracks occurred in the upper or lower surface of the honeycomb substrate.

As will be understood from the foregoing description, the organic binder had so far been heat-treated for extended periods of time, which, however, can now be greatly shortened.

The oxygen concentration in the dewaxing step of removing the organic binder needs not be maintained constant at all times but may be successively changed to an optimum oxygen concentration to meet the properties of the organic binder.

TABLE 2
Comparative Example

| | O₂ concentration | Heating time (h) | Rate of crack |
|---|---|---|---|
| | in carrier gas | in which no defect | occurrence |
| | (%) | occurs up to 700° C. | (%) |
| \mathring{1} | 21 | 15 | 0 |
| \mathring{2} | 21 | 12 | 0 |
| \mathring{3} | 21 | 10 | 2 |

In the Example shown in FIG. 1, the electric heater 31 is used as heating means for heating the carrier gas, to which, however, the invention is in no way limited, and a burner system may be employed.

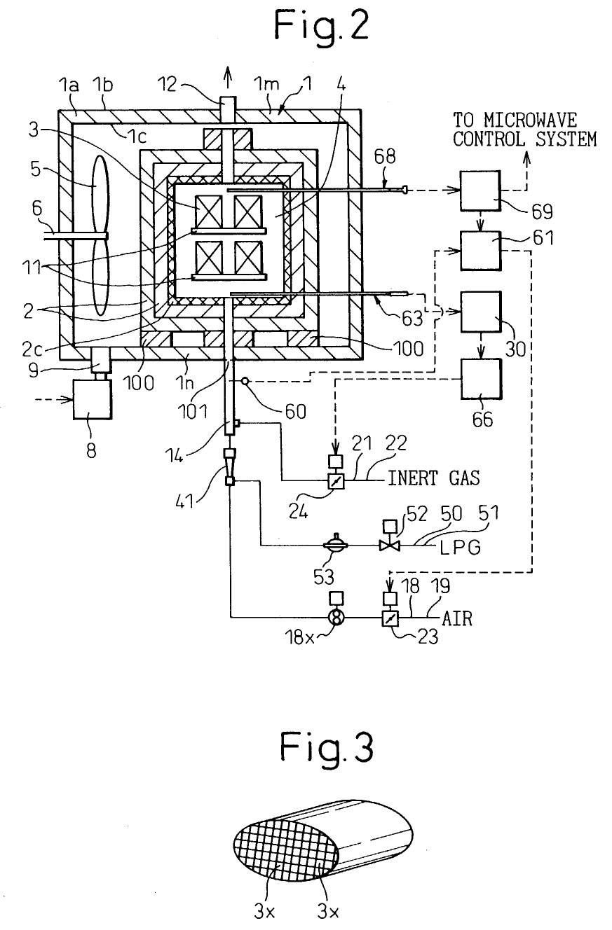

An Example shown in FIG. 2 is basically constituted in the same manner as the above Example. In this Example, too, an introduction passage for introducing the carrier gas into the carrier gas introduction pipes 14 includes feed means 19 having an oxygen-containing gas introduction passage 18 for feeding the oxygen-containing gas (air or the like), feed means 22 having an inert gas introduction passage 21 for feeding an inert gas (nitrogen gas, argon gas), and feed means 50 having a fuel gas introduction passage 50 for feeding a fuel gas (e.g., LPG gas).

The fuel gas is not limited to the LPG gas but may be any other fuel gas. The fuel gas introduction passage 50 is provided with an open/close control valve 52 which is an electromagnetic valve and with a zero governor 53.

The oxygen-containing gas introduction passage 18 is provided with a control valve 23 for varying the flow rate of the oxygen-containing gas (e.g., oxygen-containing gas, air) per a unit time. A flow meter 18x is provided downstream of the control valve 23 to detect the flow rate of the oxygen-containing gas flowing through the oxygen-containing gas introduction passage 18.

The inert gas introduction passage 21 is provided with a control valve 24 as control means for varying the flow rate of the inert gas per a unit time.

According to this embodiment as shown in FIG. 2, the burner which is the heating means for heating the carrier gas is formed integrally with the carrier gas introduction pipe 14.

The oxygen-containing gas flowing through the oxygen-containing gas introduction passage 18 and the fuel gas from the fuel gas introduction passage 50 are mixed together through a mixer 41 to form a mixed gas. The mixed gas flows into the carrier gas introduction pipe 14 that also serves as a burner, and burns in a burner portion of the carrier gas introduction pipe 14. The inert gas in the inert gas introduction passage 21 is introduced into the carrier gas introduction pipe 14 that also serves as a burner, and is fed into the furnace chamber 4 as the carrier gas from the end of the carrier gas introduction pipe 14 together with the flame of combustion or with the combustion gas.

Referring to FIG. 2, a shielding net 101 formed of a heat resistant metal net is provided in the carrier gas introduction pipe 14 in order to suppress the infiltration of microwaves into the carrier gas introduction pipe 14. Further, a temperature sensor 60 for measuring the temperature of the carrier gas is provided in the carrier gas introduction pipe 14. The temperature of the carrier gas blown into the furnace chamber 4 is detected by the temperature sensor 60, and a detection signal is input to a carrier gas temperature controller 61. The carrier gas temperature controller 61 controls the control valve 23 to adjust the amount of the air in the mixed gas.

A sampling pipe 63 is provided near the end of the carrier gas introduction pipe 14 to sample the carrier gas blown into the furnace chamber 4 from the end of the carrier gas introduction pipe 14. The oxygen concentration in the carrier gas sampled by the sampling pipe 63 is measured by the oxygen meter 30. When the oxygen concentration of the carrier gas blown out from the end of the carrier gas introduction pipe 14 is lower than the setpoint value, a carrier gas oxygen controller 66 so works as to close the control valve 24 or to decrease the opening degree of the control valve 24 in the inert gas introduction passage 21 to thereby relatively lower the flow rate per unit time of the inert gas supplied to the carrier gas introduction pipe 14 and, hence, to relatively increase the oxygen concentration in the carrier gas so as to approach the setpoint oxygen concentration.

When the oxygen concentration of the carrier gas measured by the oxygen meter 30 is higher than the setpoint value, on the other hand, the carrier gas oxygen controller 66 so works as to increase the opening degree of the control valve 24 in the inert gas introduction passage 21 to thereby relatively increase the flow rate per a unit time of the inert gas supplied to the carrier gas introduction pipe 14 and, hence, to relatively lower the oxygen concentration in the carrier gas so as to approach the setpoint oxygen concentration.

Referring to FIG. 2, provision is made of a gas temperature sensor 68 for measuring the temperature of the gas in the furnace chamber 4. A signal measured by the gas temperature sensor 68 is input to a firing furnace temperature controller 69 which works to maintain the gas temperature in the furnace to lie in a predetermined range.

This embodiment, too, works in the same manner as the above-mentioned embodiment; i.e., the carrier gas blown out from the carrier gas introduction pipe 14 contains oxygen enabling carbon and carbides, stemming from the organic binder, to burn. However, this carrier gas has an oxygen concentration lower than that of the air and suppresses the burning of carbon and carbides stemming from the organic binder as compared to when the air only is used as the carrier gas. In the sintering step, which is an important step effected after the dewaxing step of removing the organic binder, therefore, carbon and carbides burn in a suppressed manner thereby to suppress a local sharp temperature rise in the material being fired.

In this embodiment, too, as described above, carbon and carbides, stemming from the organic binder, burn without causing a local and sharp temperature rise in the material 3 being fired. It is therefore possible to shorten the time of the dewaxing step of removing the organic binder from the material that is fired.

According to the present invention as described above, the carrier gas having a suppressed oxygen concentration is introduced into the microwave firing furnace in order to suppress the oxygen concentration in the microwave firing furnace and to suppress early burning of carbon and carbides stemming from the organic binder. This is advantageous for lowering the temperature differential in the material being fired. The temperature differential can be thus lowered in the material being fired and, as a result, the organic binder is removed from the material being fired within a shorter period of time.

While the invention has been described by reference to specific embodiments chosen for purposes of illustration, it should be apparent that numerous modifications could be made thereto by those skilled in the art without departing from the basic concept and scope of the invention.

1. A microwave firing furnace comprising microwave heating means and a furnace chamber for holding a material to be fired containing an organic binder, the microwave firing furnace further having a carrier gas introduction pipe for introducing a carrier gas that contains oxygen at a concentration lower than that of the air to suppress the burning of the organic binder.

2. A microwave firing furnace according to claim 1, further comprising gas feed means for feeding, into the carrier gas introduction pipe, the carrier gas that contains oxygen at a concentration lower than that of the air to suppress the burning of the organic binder.

3. A microwave firing furnace according to claim 1, further comprising heating means for heating said carrier gas to lie in a temperature region where at least said organic binder is decomposed or removed.

4. A microwave firing furnace according to claim 1, further comprising heating means for heating said carrier gas before said carrier gas comes into contact with the material to be fired in said furnace chamber.

5. A microwave firing furnace according to any one of claims 1 to 4, wherein the oxygen concentration in said carrier gas is set to be from 2% to 16% in terms of a volume ratio.

6. A microwave firing furnace according to claim 1, further comprising control means for variably controlling the oxygen concentration in said carrier gas.

7. A microwave firing furnace according to claim 1, wherein said carrier gas introduction pipe also serves as a burner to introduce the carrier gas that is burning into said furnace chamber.

8. A microwave firing method of holding and firing the material to be fired containing an organic binder in a furnace chamber of a microwave firing surface while introducing, into said furnace chamber, a carrier gas containing oxygen at a concentration lower than that of the air in a temperature range where at least said organic binder burns or is removed.
